(19) United States
(12) Patent Application Publication
(10) Pub. No.: US 2026/0141093 A1
(43) Pub. Date: May 21, 2026

(54) CONTROLLED APPLICATION SHARING IN A VIDEO CONFERENCING SYSTEM

(71) Applicant: International Business Machines Corporation, Armonk, NY (US)

(72) Inventors: Jing Xing, BEIJING (CN); Da Li Liu, BEIJING (CN); Xi Bo Zhu, BEIJING (CN); Ling Ling SH Hu, ShangHai (CN); Dong Yan Yang, BEIJING (CN); Dan Li, BEIJING (CN)

(73) Assignee: International Business Machines Corporation, Armonk, NY (US)

(21) Appl. No.: 18/950,020

(22) Filed: Nov. 16, 2024

(51) Int. Cl. G06F 21/62; H04L 65/65

(52) U.S. Cl. CPC G06F 21/62; H04L 65/65; G06F 2221/2141

(57) ABSTRACT

An embodiment includes responsive to receiving a request to share a segment of a media stream by a video conferencing server, computing an access metric from the request where the access metric describes access to the segment by a user. The embodiment includes extracting the segment from the media stream based on the access metric where the segment is a portion of the media stream. The embodiment also includes sending the segment that is separate from the media stream to a device of the user where the segment is displayed on the device.

### BACKGROUND

The present invention relates generally to video conferencing. More particularly, the present invention relates to a method, system, and computer program for Controlled Application Sharing in a Video Conferencing System.

Video conferencing is a technology that enables users in different locations and using different devices to hold real-time face to face meetings. Video conferencing systems work by transmitting audio and/or video between two or more devices over a network, such as the Internet. Video conferencing may be used for various purposes such as business meetings, education courses, medical appointments, and social events. Platforms for video conferencing systems may include features that allow users to share their screens, chat with one another, record video conferencing sessions, as well as other features.

### SUMMARY

The illustrative embodiments provide for Controlled Application Sharing in a Video Conferencing System. An embodiment includes responsive to receiving a request to share a segment of a media stream by a video conferencing server, computing an access metric from the request wherein the access metric describes access to the segment by a user. The embodiment includes extracting the segment from the media stream based on the access metric wherein the segment is a portion of the media stream. The embodiment also includes sending the segment that is separate from the media stream to a device of the user wherein the segment is displayed on the device.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of a presenter device sharing of a segment of a media stream in a video conferencing environment in accordance with an illustrative embodiment;

FIG. 3 depicts a block diagram of a user interface of a presenter device sharing of a segment of a media stream in a video conferencing environment in accordance with an illustrative embodiment;

FIG. 4 depicts a block diagram displaying the sharing of a segment of a media stream in a video conferencing environment in accordance with an illustrative embodiment;

FIG. 5 depicts a table of chunk data message types in an environment in accordance with an illustrative embodiment;

FIG. 6 depicts a flowchart that illustrates an example method for sharing a segment of a media stream by a video conferencing server in an environment in accordance with an illustrative embodiment; and

FIG. 7 depicts a system diagram that illustrates an example computing system for sharing a segment of a media stream by a video conferencing server in an environment in accordance with an illustrative embodiment.

### DETAILED DESCRIPTION

Generally, video conferencing systems allow a presenter to share one or more media streams such as images, documents, applications, and/or user interface windows with other participants of the video conferencing session. For example, a presenter may open a graphical user interface to initiate the video conferencing session, and prior to or during the session select a share button to share the contents of the presenter's screen. The content may be an image, video, audio or a user interface window of an application running on the presenter's device and displayed on the device. Selecting a share button may capture the contents of the screen which is then transmitted to the shared device.

However, while sharing the presenter's screen has already been described, there are issues such as every user in the video conferencing session will receive all the shared applications, but the presenter or policy may require that some applications are not seen by everyone due to confidential, privacy or policy needs. Additionally, sharing the same applications to all the audiences unnecessarily will result in a waste of bandwidth and users' loss of focus and attention.

The following description provides examples of embodiments of the present disclosure, and variations and substitutions may be made in other embodiments. Several examples will now be provided to further clarify various aspects of the present disclosure.

Example 1: A computer-implemented method that comprises responsive to receiving a request to share a segment of a media stream by a video conferencing server, computing an access metric from the request wherein the access metric describes access to the segment by a user. The method further comprises extracting the segment from the media stream based on the access metric wherein the segment is a portion of the media stream. The method further comprises sending the segment that is separate from the media stream to a device of the user wherein the segment is displayed on the device.

The above limitations advantageously enable a video conferencing server to receive a request from a presenter to control access to a segment of a media stream. Based on the computed access metric, the user is sent a segment of the media stream that is described in the access metric. These limitations improve on the functionality of a video conferencing system, and further improve computer functionality since the central processing unit may require less usage to process the media stream and the access metric.

The term user as disclosed herein may comprise a user of a video conferencing system and comprises but is not limited to a presenter, a participant, an observer, an application, a group comprising all or some of the aforementioned or a combination thereof.

The term media stream as disclosed herein may comprise a formatted sequence of digital information such as images, audio, video, application data that is resistant to degradations introduced by the communication network, bridging the gap between the information source and the electrical signal required for transmission over the communication network. However, use of this example is not intended to be limiting, but is instead used for descriptive purposes only.

The term portion as disclosed herein may comprise a part, a section, a fraction or a whole.

The term segment as disclosed herein may comprise a portion, a part of, a section, or whole of a media stream.

The term access metric as disclosed herein may comprise a description, a representation, a list, or a mapping of access of a user to a segment of the media stream.

Example 2: The limitations of Example 1, further comprising sending a message from a presenter device using an extended message protocol where the extended message protocol comprises the media stream and is extended with the message comprising the access metric.

The above limitations advantageously enable a video conferencing server to receive a request from a presenter device to control access to a segment of a media stream using an extended message protocol where the extended message protocol comprises the media stream and is extended with the message comprising the access metric. Based on the computed access metric, the user is sent a segment of the media stream that is described in the access metric. These limitations improve on the functionality of a video conferencing system by extending a message protocol with the message comprising the access metric. These limitations further improve computer functionality since the central processing unit may require less usage to process the media stream and the access metric since the extended message protocol is used for the media stream and the access metric. Additionally, the limitations realize the benefits described with respect to Example 1.

The term extended message protocol as disclosed herein may mean adding a functionality to an existing message protocol without meaningfully changing the way the messages are processed or handled. This may mean for example that the byte order, alignment, and format of the messages using the extended messaging protocol are not substantially changed.

Example 3: The limitations of Example 1, further comprising receiving by the device of the user from the video conferencing server the segment that is separate from the media stream.

The above limitations advantageously enable a video conferencing server to receive a request from a presenter device to control access to a segment of a media stream where the segment is separate from the media stream. These limitations improve on the functionality of a video conferencing system by sending a segment to a user based on the access metric. These limitations further improve network usage since only the entire media stream is not sent to the user. Additionally, the limitations realize the benefits described with respect to Examples 1-2.

Example 4: The limitations of Example 1, where the request is received using an extended messaging protocol comprising a message where the message further comprises the access metric.

The above limitations advantageously enable a video conferencing server to receive a request using an extended messaging protocol where the message protocol is extended with a message that comprises an access metric. These limitations improve on the functionality of a video conferencing server by receiving an extended message protocol with the message comprising the access metric. These limitations further improve computer functionality since the central processing unit may require less usage to process the media stream and the access metric since the extended message protocol is used for the media stream and the access metric. Additionally, the limitations realize the benefits described with respect to Examples 1-3.

Example 5: The limitations of Example 1, where the media stream is generated at a presenter device that is sharing the segment to the device of the user.

The above limitations advantageously enable a video conferencing server to receive a media stream from a presenter device. Additionally, the limitations realize the benefits described with respect to Examples 1-4.

Example 6: The limitations of Example 1, where the access metric comprises an access control list.

The above limitations advantageously enable a video conferencing server to receive a message using an extended messaging protocol where the message is an access control list which describes access to a segment of the media stream by a user of the video conferencing session. Additionally, the limitations realize the benefits described with respect to Examples 1-5.

Example 7: The limitations of Example 1, where the sending the segment is contemporaneous with the media stream.

The above limitations advantageously enable a video conferencing server to send a segment based on an access metric contemporaneous with sending the media stream to other users. These limitations improve on the functionality of a video conferencing system to enable different users in the video conferencing session to receive the media stream and a segment which they have access to without a time loss or out of synchronous behavior. Additionally, the limitations realize the benefits described with respect to Examples 1-6.

The term contemporaneous as disclosed herein may mean at the same time, synchronized, in parallel, or similar meaning, or in combination.

Example 8: A computer program product comprising one or more computer readable storage media, and program instructions collectively stored on the one or more computer readable storage media, the program instructions executable by a processor to cause the processor to perform the method according to any of Examples 1-7. The computer program product of Example 8 realizes the benefits described with respect to Examples 1-7. The computer program product of Example 8 can advantageously be implemented into a variety of computer program products.

Example 9: A computer system comprising a processor and one or more computer readable storage media, and program instructions collectively stored on the one or more computer readable storage media, the program instructions executable by the processor to cause the processor to perform the method according to any of Examples 1-7. The computer system of Example 7 realizes the benefits described with respect to Examples 1-7. The computer system of Example 9 can advantageously be implemented into a variety of computer devices.

Example 10: A computer-implemented method that comprises responsive to receiving a request to share a segment of a media stream by a video conferencing server, computing an access metric from the request wherein the access metric describes access to the segment by a user. The method further comprises extracting the segment from the media stream based on the access metric wherein the segment is a portion of the media stream. The method further comprises sending the segment that is separate from the media stream to a device of the user wherein the segment is displayed on the device. The method further comprises wherein the request is received using an extended messaging protocol comprising a message wherein the message further comprises the access metric. The method further comprises wherein the sending the segment is contemporaneous with the media stream. The above limitations realize the technical benefits described with respect to Examples 1-7.

Example 11: A computer program product comprising one or more computer readable storage media, and program instructions collectively stored on the one or more computer readable storage media, the program instructions executable by a processor to cause the processor to perform the method according to Example 10. The computer program product of Example 9 realizes the technical benefits described with respect to Examples 1-7. The computer program product of Example 9 can advantageously be implemented into a variety of computer program products.

Example 12: A system comprising one or more processors and one or more computer-readable storage media collectively storing program instructions which, when executed by the one or more processors, are configured to cause the one or more processors to perform the method according to Example 10. The system of Example 12 realizes the benefits of Examples 1-7. The system of Example 12 can advantageously be implemented into a variety of computing devices.

Aspects of the present disclosure can be implemented in a variety of technical use cases. The following use cases are merely exemplary and are not intended to limit the scope of the disclosure.

In a use case, a video conferencing server receives a request from a presenter of a video conferencing session to share a segment of a media stream. The request is received using an extended messaging protocol comprising a message where the message further comprises the access metric. The video conferencing server computes an access metric from the request where the access metric describes access to the segment by a user. The video conferencing server extracts the segment from the media stream based on the access metric where the segment is a portion of the media stream. The video conferencing server sends the segment that is separate from the media stream to a device of the user where the segment is displayed on the device.

In another use case, a presenter in a video conferencing session selects an application from the media stream and selects a user with access to the application to create an access control list. The presenter's device extends a message protocol by modifying a message to include the access control list. The message is sent together with the message comprising the media stream to the video conferencing server.

The present disclosure provides for a method, a machine-readable medium, and a system for Controlled Application Sharing in a Video Conferencing System.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

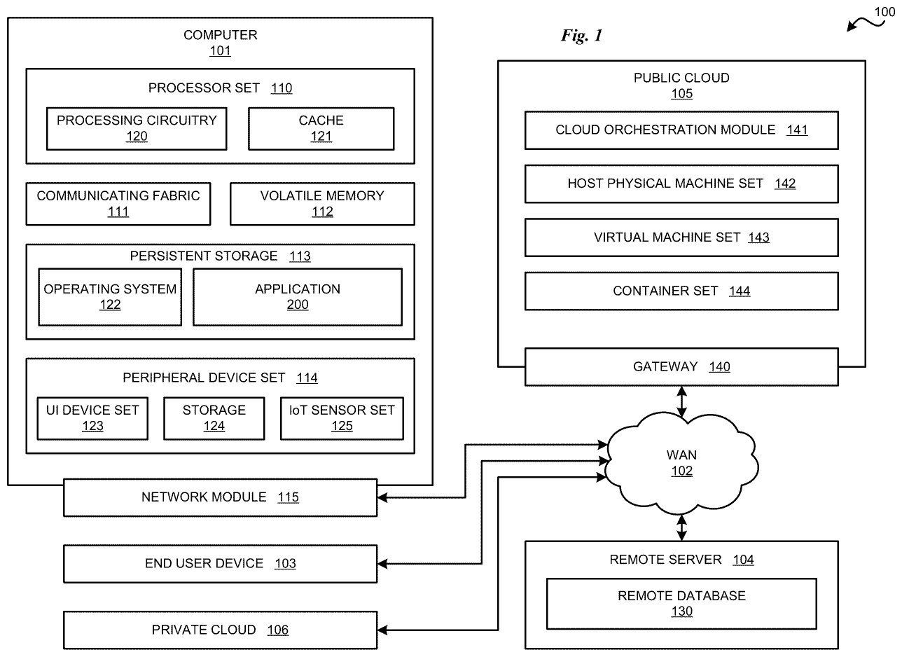

With reference to FIG. 1, this figure depicts a block diagram of a computing environment 100. Data center environment 100 contains an example of an environment for the execution of at least some of the computer code involved in performing the inventive methods, such as an Application module 200 that provides Controlled Application Sharing in a Video Conferencing System. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

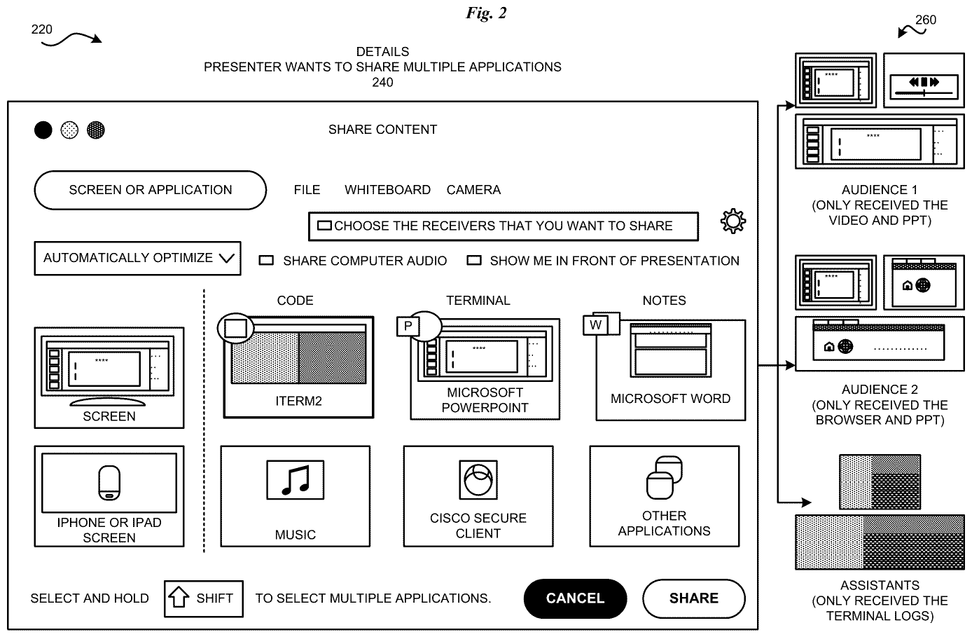

FIG. 2 depicts a block diagram of a presenter device sharing of a segment of a media stream in a video conferencing environment in accordance with an illustrative embodiment. In a particular embodiment, the components of the diagram 220 show aspects of the Application 200 of FIG. 1.

In the illustrated embodiment, the media feed comprises an initiated or ongoing stream of video, image and/or audio used to represent a presenter of a video conferencing session 240 to other participants 260 of the video conferencing session. More specifically, the media feed comprises one or more of: real time video and/or audio of a presenter/participant, real time video and/or audio of a participant, and/or an image used to represent the participants.

In embodiments, the video conferencing environment system enables communication between the video conference participants. The system may comprise of a network of one or more video conferencing servers and computing networks including the Internet, intranet, a local area network, a wide area network, a wireless data network, and any other such networks or combinations thereof.

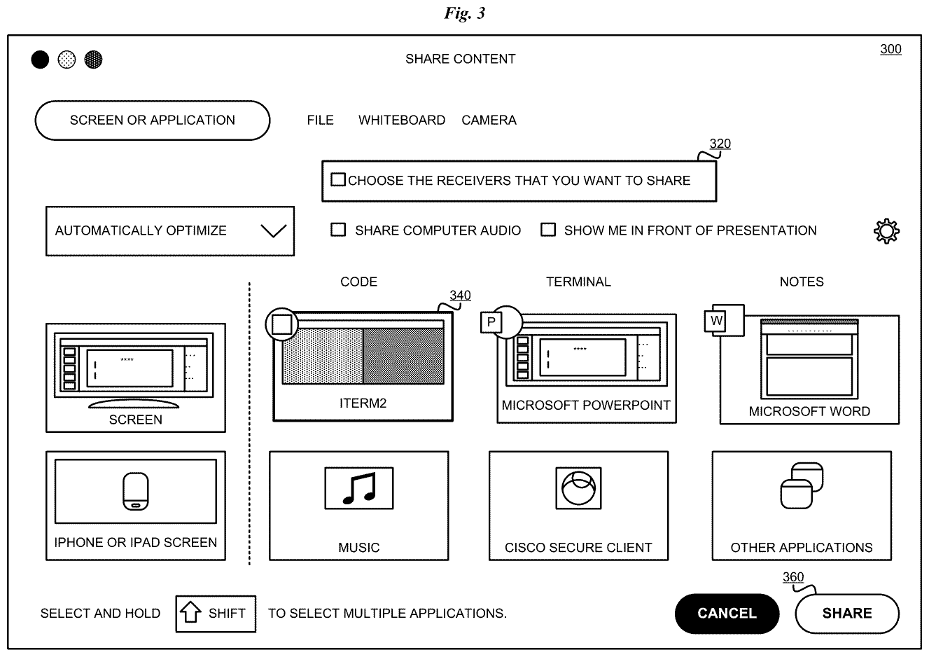

FIG. 3 depicts a block diagram of a user interface of a presenter device sharing of a segment of a media stream in a video conferencing environment in accordance with an illustrative embodiment. In a particular embodiment, the components of the diagram 300 show aspects of the Application 200 of FIG. 1.

In the illustrated embodiment, a presenter of the media stream, via a user device, opens the media stream, for example, using an appropriate application such as a native application with a graphical user interface (GUI) 300 and the applications or windows that are available for streaming 340 in the media stream. The presenter selects the Choose the receivers you want to share 320 and click on the Share button 360 to invoke the sharing of a segment of the media feed. The presenter may share an entire stream of the application or a segment where the segment may be delineated by user action, time, or similar action or a combination thereof.

In an embodiment, the presenter selects the Choose the receivers you want to share 320 invokes a list of receivers or users with whom the presenter intends to share the segment. For example, the list of users may comprise individuals or a group of individuals who may or may not currently be in the video conferencing session. A group may be based on team, location or other similar criteria or combinations thereof.

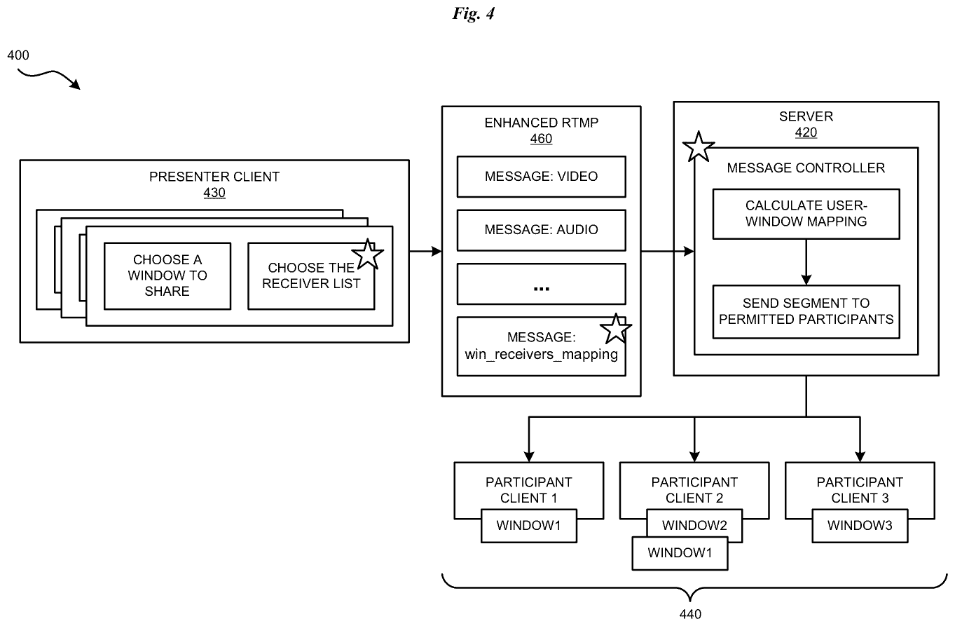

FIG. 4 depicts a block diagram displaying the sharing of a segment of a media stream in a video conferencing environment in accordance with an illustrative embodiment. In a particular embodiment, the components of the diagram 400 show aspects of the Application 200 of FIG. 1.

In the illustrated embodiment, a video conferencing server 420 receives a request to share a segment of a media stream from a Presenter Client 430 with Participant Clients 440: Participant Client1, Participant Client2 and Participant Client3 over an enhanced Real Time Messaging Protocol (RTMP) 460. In embodiments, the Presenter Client 430 may comprise a computing device configured to host a video conferencing client. For example, the Presenter Client 430 may enable the presenter to choose a window to share and choose from the receiver list using a Graphical User Interface (GUI) as described above. A message comprising a message chunk is generated by the Presenter Client with an access metric which is sent using an extended message protocol (e.g. extended RTMP) 460 to the Participant Clients 440 via the video conferencing server 420.

In an embodiment, the video conferencing server 420, determines the segment and the Participants to share the segment. A Message Controller on the server may process the message to calculate user window mapping from the access metric of the received message to determine a mapping of a user and his or her access to a segment of the media stream such as an application or window. The server extracts the segment from the media stream and sends the segment to the permitted participants.

In an embodiment, a messaging protocol e.g. RTMP provides a bidirectional message multiplex service over a reliable stream transport, such as Transmission Control Protocol (TCP), intended to carry parallel streams of video, audio, and data messages, with associated timing information, between a pair of communicating peers. Implementations typically assign different priorities to different classes of messages, which can affect the order in which messages are enqueued to the underlying stream transport when transport capacity is constrained.

The format of a message that can be split into chunks to support multiplexing depends on a higher-level protocol. Each chunk stream carries messages of one type from one message stream. Each chunk that is created has a unique ID associated with it called chunk stream ID. The chunks are transmitted over the network. While transmitting, each chunk must be sent in full before the next chunk. At the receiver end, the chunks are assembled into messages based on the chunk stream ID.

Chunking allows large messages at the higher-level protocol to be broken into smaller messages, for example to prevent large low-priority messages (such as video) from blocking smaller high-priority messages (such as audio or control). Chunking also allows small messages to be sent with less overhead, as the chunk header contains a compressed representation of information that would otherwise have to be included in the message itself.

In embodiments, the chunk size is configurable. It can be set using a Set Chunk Size control message. Larger chunk sizes reduce CPU usage, but may also commit to larger writes that may delay other content on lower bandwidth connections. Smaller chunks are not good for high bit rate streaming. Chunk size is maintained independently for each direction.

In some embodiments, each chunk consists of a header and data. The header may comprise of three parts:

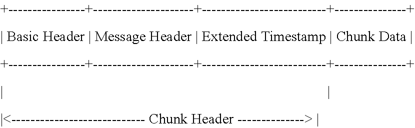

A message header may comprise:

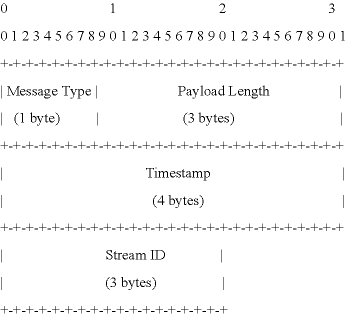

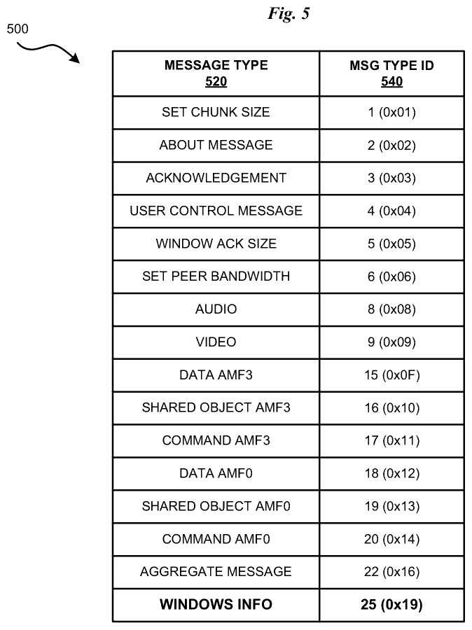

FIG. 5 depicts a table of chunk data message types in an environment in accordance with an illustrative embodiment. In a particular embodiment, the components of the diagram 500 show aspects of the Application 200 of FIG. 1.

In the illustrated embodiment, a table of chunk data message types of a message header comprises a Message Type 520 and MSG (Message) TYPE ID 540. For example, Set Chunk Size may be assigned MSG TYPE ID of 1 (0x01).

The write enabled regions are condensed to, for example, A>1|A>2|A>3|A>4, and are each x4000 bytes. Mappings are to real physical addresses; no additional translation is necessary.

In another embodiment, the message header is extended with a Message Type, Windows Info with an assigned TYPE ID of 25 (0x19). It should be noted that “Windows Info” and the value 25 are exemplary and other terms and values may be used. For example, the chunk, comprising the message header and data may comprise:

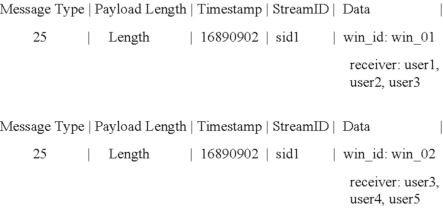

In the example, the Message Type 25 identifies the message header is of a type Windows Info. Two messages are configured for the same StreamID sid1: the first message comprises of indicating the receivers of win_id=win_01 are user1, user2, and user3; the second message comprises of indicating the receivers of win_id=win_02 are user3, user4, and user5. Although the data in this example is plaintext, the data format may also include but is not limited to binary, hash, integer, and text expression etc. It should also be understood that “user” and “win” are exemplary and the Data field may indicate a group of users or an application's access to a segment of a video conferencing feed such as applications, files, data streams etc.

In an embodiment, a processor in a video conferencing user device receives a selection from a GUI of a segment of a video conferencing feed and a user that is granted access to the segment. The selected segment and user mapping is sent to a message protocol module that extends the message protocol. For example, the processor instructs the message protocol module to extract the StreamID from the message that contains the media stream. The processor then causes the message protocol module to create another message with the same StreamID and selected segment and an access metric such as an access control list (ACL) of the user in the data field. In an example, the ACL may comprise of a mapping of applications and/or windows and the users granted access to read, write, and/or transform or combinations thereof. In another embodiment, the user ACL that is granted access is determined from a mapping such as group name, location or some other identifier that maps to a user.

In some embodiments, a processor of a video conferencing server extracts the request that is a data field of the received message chunk from a user device. In an example, extracting the data field may comprise reading the contents of the data field from memory, and transforming the contents from one format to another such as by applying a binary data stream to text converter. The processor then computes an access metric from the transformed contents. For example, the processor may generate a mapping of a user to windows or applications the user can access:

| | |
|---|---|
| user1 | win_01 |
| user2 | win_01 |
| user3 | win_01, win_02 |

The processor of the video conferencing server in another embodiment uses the StreamID of the message chunk to extract the segment of the media stream. For example, the processor extracts the StreamID from the received message chunk, and then uses the StreamID to retrieve the message chunk containing the media stream. Using a known technique, in a case where multiple media streams are shared to a video conferencing session and each media stream is identified by a StreamID, the processor determines if the data field contains the segment based on the StreamID.

In another embodiment, the segment is a section or fragment of a media stream. For example, the media stream may comprise of several applications or windows in the media stream, and the segment is one of the applications. The processor uses the StreamID and other identifying parameters such as track and channel identifiers and media metrics to extract the segment of the media stream.

In another embodiment, a video conferencing server extracts the data field of the received message from a user device where the transformed content of the data field is an identifier. The process uses the identifier to look up the identifier in an archive to calculate a user mapping. For example, the content of the data field may be “app_id=app_01 receiver_id=Identifier1”. In this example, the process determines the users that map to “Identifier1” in a stored archive.

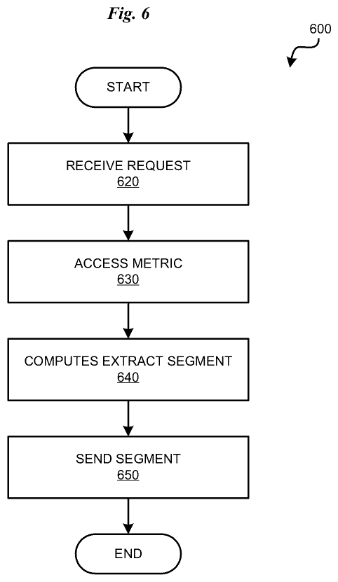

FIG. 6 depicts a flowchart that illustrates an example method for sharing a segment of a media stream by a video conferencing server in an environment in accordance with an illustrative embodiment. In a particular embodiment, the components of the diagram 600 show aspects of the Application 200 of FIG. 1.

In the illustrated embodiment, the video conferencing server receives a request 620 to share a segment of a media stream. Responsive to the request, the server computing an access metric 630 from the request wherein the access metric comprises access of a user to the segment. Based on the access metric, a segment is extracted 640 from the media stream. The extracted segment that is separate from the media stream is sent 650 to a device of the user where the segment is displayed on the device.

In embodiments, extracting a segment from a media stream 640 comprises using a known multimedia encoder/decoder and application programming interfaces (API) to a graphical processing unit (GPU) to process the media stream. In an example, the encoder/decoder works in concert with the GPU and uses application-specific algorithms to access the underlying data and applies binary manipulation of media stream metrics including but not limited to timestamps, frequencies, channels, tracks and formats to extract the segment of the media stream. The video conferencing server may make use of these techniques to transform a window or application identifier in the media stream to a segment.

In other embodiments, the extracted segment is sent 650 to a device of a user such as a participant in the video conferencing session where the segment is contemporaneous with the media stream. The extracted segment is synchronized to the media stream meaning the segment will play back at the exact same time, preventing any noticeable audio-video lag or desync issues when the stream is rendered or played back. For example, the central processing unit (CPU) and the GPU may coordinate the processing of the received media stream in extracting the segment and sending it to the user device. In another example, this synchronization may be achieved through a parallel computing platform and API model. This allows accelerated use of graphics processing units (GPUs), allowing a direct access to the GPU's virtual instruction set and parallel computational elements for the required execution ensuring each segment within the stream is intended to be played back in a coordinated manner with the unsegmented media stream on a user device.

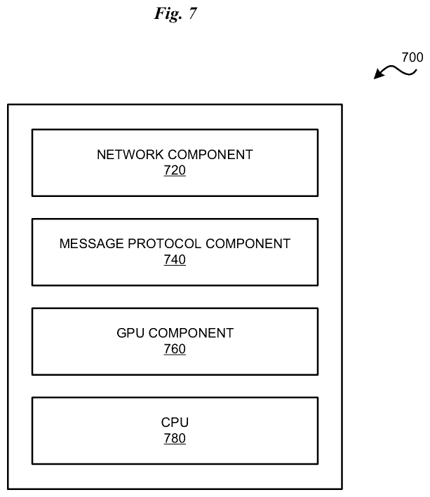

FIG. 7 depicts a system diagram that illustrates an example computing system for sharing a segment of a media stream by a video conferencing server in an environment in accordance with an illustrative embodiment. In a particular embodiment, the components of the diagram 700 show aspects of the Application 200 of FIG. 1.

In the illustrated embodiment, a video conferencing server may comprise a network component 720. For example, the network component may comprise a network adaptor, a socket, a graphics card, one or more routers, switches, hubs, and/or other network connectivity devices. The network component may transmit and/or receive data via network links such as data may be transmitted and/or received using Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet Protocols (TCP/IP), or other protocols and/or systems suitable for transmitting and receiving data. Data may be transmitted and/or received wirelessly or may utilize cabled network connections or telecom connections such as an Ethernet RJ45/Category 5 Ethernet connection, a fiber connection, a traditional phone wireline connection, a cable connection or other wired network connection.

In an embodiment, the video conferencing server may comprise a message protocol component 740. In embodiments, the message protocol component may comprise of receiving message data from the network component to process message chunk data as described herein. For example, the message protocol component may retrieve the message chunk from memory to manipulate the message chunk to extract the access metric.

In another embodiment, the video conferencing server may comprise a GPU component 760. The GPU component in embodiments may be configured to run in parallel with the central processing unit (CPU) 780 to coordinate the processing of the media stream and sharing of a segment contemporaneously with the media stream as described herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
responsive to receiving a request to share a segment of a media stream by a video conferencing server, computing an access metric from the request wherein the access metric describes access to the segment by a user;
extracting the segment from the media stream based on the access metric wherein the segment is a portion of the media stream; and
sending the segment that is separate from the media stream to a device of the user wherein the segment is displayed on the device.

2. The computer-implemented method of claim 1, wherein the request is received using an extended messaging protocol comprising a message wherein the message further comprises the access metric.

3. The computer-implemented method of claim 1, further comprising sending a message from a presenter device using an extended message protocol wherein the extended message protocol comprises the media stream and is extended with the message comprising the access metric.

4. The computer-implemented method of claim 1, further comprising receiving by the device of the user from the video conferencing server the segment that is separate from the media stream.

5. The computer-implemented method of claim 1, wherein the access metric comprises an access control list.

6. The computer-implemented method of claim 1, wherein the sending the segment is contemporaneous with the media stream.

7. The computer-implemented method of claim 1, wherein the media stream is generated at a presenter device that is sharing the segment to the device of the user.

8. A computer program product comprising one or more computer readable storage media, and program instructions collectively stored on the one or more computer readable storage media, the program instructions executable by a processor to cause the processor to perform operations comprising:
responsive to receiving a request to share a segment of a media stream by a video conferencing server, computing an access metric from the request wherein the access metric describes access to the segment by a user;
extracting the segment from the media stream based on the access metric wherein the segment is a portion of the media stream; and
sending the segment that is separate from the media stream to a device of the user wherein the segment is displayed on the device.

9. The computer program product of claim 8, wherein the request is received using an extended messaging protocol comprising a message wherein the message further comprises the access metric.

10. The computer program product of claim 8, further comprising sending a message from a presenter device using an extended message protocol wherein the extended message protocol comprises the media stream and is extended with the message comprising the access metric.

11. The computer program product of claim 8, further comprising receiving by the device of the user from the video conferencing server the segment that is separate from the media stream.

12. The computer program product of claim 8, wherein the access metric comprises an access control list.

13. The computer program product of claim 8, wherein the sending the segment is contemporaneous with the media stream.

14. The computer program product of claim 8, wherein the media stream is generated at a presenter device that is sharing the segment to the device of the user.

15. A computer system comprising a processor and one or more computer readable storage media, and program instructions collectively stored on the one or more computer readable storage media, the program instructions executable by the processor to cause the processor to perform operations comprising:
responsive to receiving a request to share a segment of a media stream by a video conferencing server, computing an access metric from the request wherein the access metric describes access to the segment by a user;
extracting the segment from the media stream based on the access metric wherein the segment is a portion of the media stream; and
sending the segment that is separate from the media stream to a device of the user wherein the segment is displayed on the device.

16. The computer system of claim 15, wherein the request is received using an extended messaging protocol comprising a message wherein the message further comprises the access metric.

17. The computer system of claim 15, further comprising sending a message from a presenter device using an extended message protocol wherein the extended message protocol comprises the media stream and is extended with the message comprising the access metric.

18. The computer system of claim 15, further comprising receiving by the device of the user from the video conferencing server the segment that is separate from the media stream.

19. The computer system of claim 15, wherein the access metric comprises an access control list.

20. The computer system of claim 15, wherein the sending the segment is contemporaneous with the media stream.
